(19) United States
(12) Patent Application Publication
(10) Pub. No.: US 2025/0000038 A1
(43) Pub. Date: Jan. 2, 2025

(54) ORCHID PROPAGATION MEDIUM

(71) Applicant: PROFILE PRODUCTS LLC, Buffalo Grove, IL (US)

(72) Inventors: James CHITTUM, North Yarmouth, ME (US); Alfred de VREEZE, Kortenhoef (NL); Edwin VALSTAR, Den Haag (NL)

(73) Assignee: PROFILE PRODUCTS LLC, Buffalo Grove, IL (US)

(21) Appl. No.: 18/760,234

(22) Filed: Jul. 1, 2024

Related U.S. Application Data
(60) Provisional application No. 63/510,900, filed on Jun. 29, 2023.

(51) Int. Cl. A01G 24/44

(52) U.S. Cl. CPC A01G 24/44

(57) ABSTRACT

A plant growing medium comprising a self-supporting, semi-rigid body including at least two discreet parts, each part having a set of dimensions including a first thickness and a recess in an inner portion of the part, the at least two discreet parts being structured to cooperatively form the body, the body structured to provide support to plant roots.

### CROSS-REFERENCE TO RELATED APPLICATIONS

This application claims the benefit of U.S. provisional application Ser. No. 63/510,900 filed Jun. 29, 2023, the disclosure of which is hereby incorporated in its entirety by reference herein.

### TECHNICAL FIELD

The present disclosure relates to a propagation medium, specifically medium for propagation of orchids, and methods of making and using the same.

### BACKGROUND

Potted orchids have become an important commercial item on the mainstream floral market worldwide. Despite the fact that orchids have been cultivated and adapted for indoor environments for hundreds of years, growing orchids still presents a number of challenges due to their fragility, tuberous air roots, and a relatively long life cycle.

### SUMMARY

In one embodiment, a plant growing medium is disclosed. The medium may be a self-supporting, semi-rigid body including at least two discreet parts. Each part may have a set of dimensions including a first thickness and a recess in an inner portion of the part. The at least two discreet parts may be structured to cooperatively form the body. The body may be structured to provide support to plant roots. The at least two discreet parts may be symmetrical. The at least two discreet parts may include more than two parts. Each one of the at least two discreet parts may include at least one edge portion, at least some of the edge portions having a second thickness different from the first thickness. The growing medium may have an open position of having the edge portions distanced from one another and a closed position of having the edge portions in contact with one another. The body may be hydrophilic. The plant growing medium may be an orchid growing medium.

In another embodiment, a plant growing medium is disclosed. The medium may be a single self-supporting, semi-rigid hydrophilic body having a central portion and edge portions. The body may be configured as a plant root support system. The central portion and/or the edge portions may have a different thickness than a remainder of the body. The body may be flat. The body may be foldable. The growing medium may have an open position of having the edge portions distanced from one another and a closed position of having the edge portions in contact with one another. The thickness between the central portion and/or the edge portions and the remainder of the body may change gradually. The plant growing medium may be an orchid growing medium.

In yet another embodiment, an orchid cultivation assembly is disclosed. The assembly may include a container having one or more sides defining a central aperture, a starter material located in the central aperture, and a self-supporting, semi-rigid hydrophilic body.

### BRIEF DESCRIPTION OF THE DRAWINGS

FIG. 1A is a photograph of a perspective view of a non-limiting example orchid growing medium, or plug, disclosed herein;

FIG. 1B is a photograph of a perspective view of another non-limiting example orchid growing medium, or plug, disclosed herein;

FIGS. 1C-1G are schematic top views of non-limiting examples orchid plugs having multiple parts disclosed herein;

FIG. 1H is a perspective side view of a non-limiting example orchid plug having two parts;

FIG. 2A is a schematic top view of a non-limiting example single-part plug in an open position;

FIG. 2B is a schematic top view of a non-limiting example single plug in a closed position;

FIG. 3 is a non-limiting example of a container;

FIG. 4 is a non-limiting example of a starter material;

FIGS. 5 and 6 are photographs of non-limiting examples of the orchid plugs disclosed herein as part of the orchid cultivation assembly including orchid plants;

FIG. 7 is a photograph of a bottom view of a non-limiting example orchid cultivation assembly including a container and the plug with orchid plant roots wrapped around the plug;

FIG. 8 is a photograph of a side view of a non-limiting example of orchid cultivation assembly including a container and the plug with orchid plant roots wrapped around the plug;

FIG. 9 is a schematic top view of a non-limiting example single part orchid growing medium with a wavy surface texture;

FIG. 10A is a perspective side view of a non-limiting example of a part of an orchid plug; and

FIG. 10B is a perspective side view of a non-limiting example a part of an orchid plug.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Orchids are plants belonging to the family Orchidaceae, one of the most diverse and widespread groups of flowering plants. Orchids are also one of the oldest flowering plants on our planet. Their myriad of colors, shapes, and sizes has intrigued mankind for thousands of years with orchid cultivation efforts dating back to ancient China, Greece, and Rome, among other cultures. Popularity of orchids has risen to the point that potted orchids have become a sought-after high value commercial article worldwide.

Yet, orchids, due to their unique structure and behavior require specific growing conditions including precise moisture levels, light intensity, temperatures, etc. Additionally, the conditions may differ for different species of orchids. For example, three of the most popular species of potted orchids include phalaenopsis, cattleya, and dendrobium. Their temperature tolerance fluctuates with dendrobium tolerating colder environments than the other two species.

Additionally, all of these species are originally epiphytes which attach themselves to tree trunks and expose some of their roots to air to absorb moisture and nutrients. The air roots form even when the orchids are cultivated and potted in containers. Yet, traditional growing media such as soil are too dense and do not accommodate the unique nature of orchid air roots. For an orchid to thrive, healthy roots are essential. Hence, a growing substrate has to be conducive to the orchid tuberous root establishment, growth, and function.

Various loose fill media have been explored for growth of epiphyte orchids such as peat moss, osmunda, tree fern, fir bark, or coconut chips. Such media are porous, allowing water drainage, but decay and disintegrate over time, often resulting in a fine material which accumulates in the planting container, causing anaerobic conditions which may result in root decay. Inert materials such as rockwool, lava rock, or perlite, on the other hand, do not experience degradation into fine particles, but may dry up rapidly and require additional fertilization.

Moreover, some of the media face additional challenges such as lack of sustainability and ecological disposal such as rockwool. Other media such as bark are prohibited from being imported to various countries due to risks associated with non-sterilized media being a source of insects. Additionally still, some of the traditionally-used media such as sphagnum moss have become scarce and underscore the need for alternatives.

Furthermore, orchids have a relatively long life cycle. It may take months to several years from germination to a flowering plant. After the germinated seed or tissue culture turns into an individual plant, it is typically moved from a lab to a greenhouse. Additional years and extensive care are needed for the plant to mature including repotting at least two times. The repotting has disadvantages such as root manipulation which may result in fracture, growth stagnation, manual labor cost, time, and spatial requirements. During the repotting, various media and containers are used such as those named above. Once the plant matures and spikes emerge, the plant is ready to bloom and be moved to a retail store within a few weeks. Its blooms may last for up to about three months in the right conditions.

Mature orchids in the right conditions go through blooming and resting cycles. Yet, many orchid owners are not familiar with the challenges connected to various media, resulting in the plant decay due to excess moisture and disintegrating growing media suffocating the roots, drying out due to lack of moisture, or lack of repeated blooms due to poor condition of the plant.

Therefore, there is a need for a growing medium which would accelerate growth and maturing of orchids such that the growers can speed up the orchid growing cycle. There is also a need for production improvements. Additionally, there is a need for a growing medium which would simplify maintenance for orchid owners once the orchid is a mature plant.

In one or more embodiments disclosed herein, a grow plug is disclosed. The grow plug may be a growing medium for one or more species of orchids, especially epiphytic species such as dendrobium, phalaenopsis, cattleya, as well as other non-orchid species, as is further discussed below.

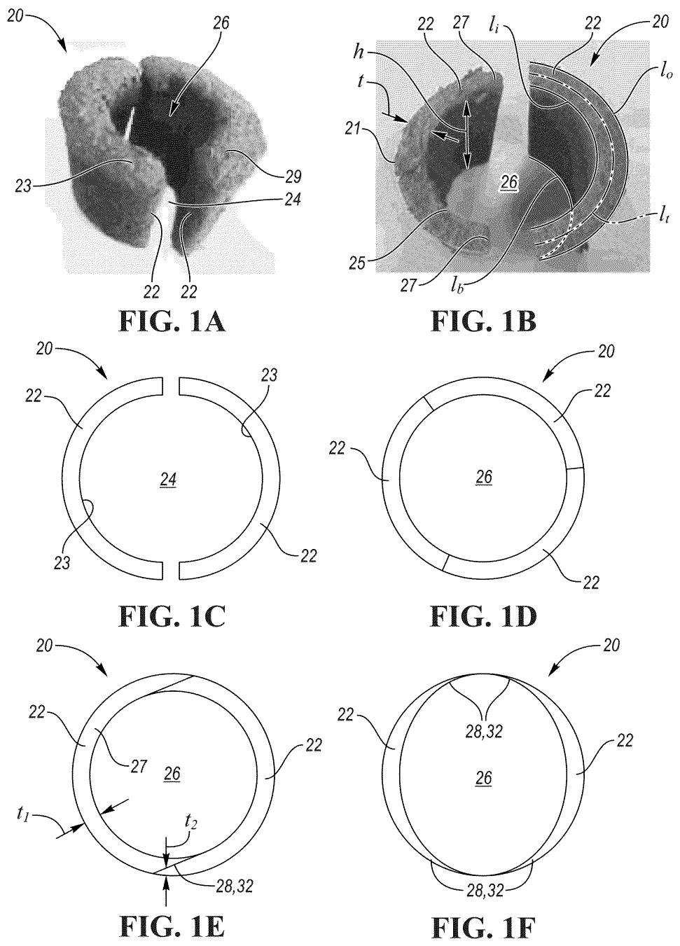

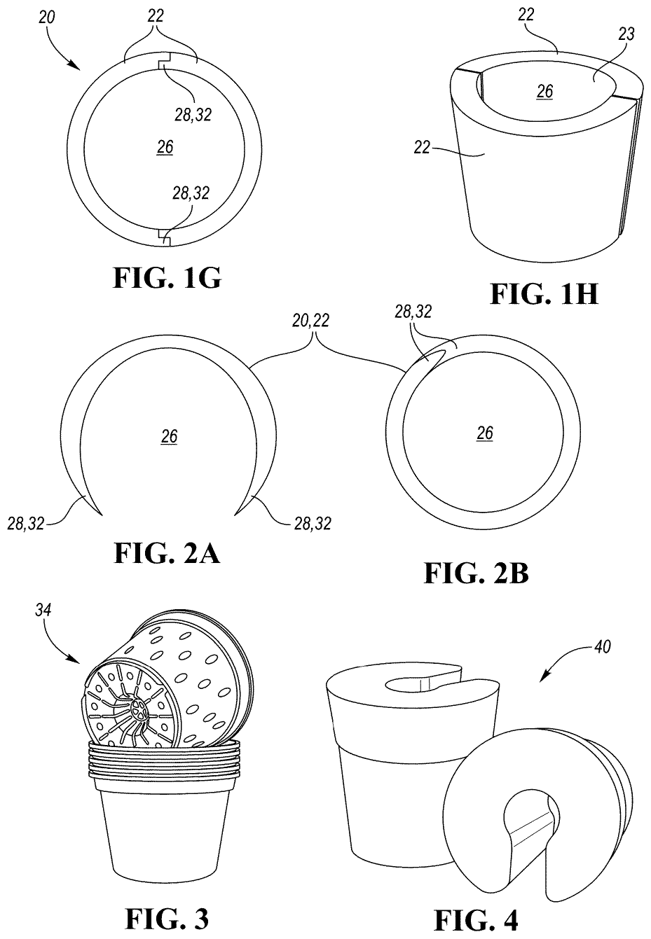

The plug may include a self-supporting, semi-rigid porous structure. The structure may include a body which may be molded, extruded, or otherwise made into a predetermined shape. The body may include one or more parts, which may cooperate together to form the plug. The body may include 1, 2, 3, 4, 5, or more parts. In a non-limiting example, the plug may include two parts such as those shown in FIGS. 1A-1H.

In the non-limiting example of FIG. 1A, the plug 20 includes two identical, symmetrical parts 22 which are configured to be brought into contact as indicated in FIG. 1A. The parts 22 may include one or more gaps 24 between the individual parts 22. Each part includes a recess 23 or arc, the two cooperating parts 22 forming a circular hole 26 as a central part of the plug. While the hole 26 is shown to be circular, it should be understood that in at least one embodiment, the hole 26 can have a non-circular shape, such as substantially circular, oval, cylindrical, arched, arcs, etc. The same concept is captured in FIG. 1H, in which two symmetrical half-moon parts 22 are shown assembled together.

Each part 22 may include an outer portion 21 with an outer surface, an inner portion 25 with an inner surface, and two edge portions 27. The part 22 has dimensions including a length, height, and thickness, schematically shown in FIG. 1B. One or more of the dimensions may be uniform or non-uniform throughout the part. For example, the length of the part may differ throughout its height. The length of the inner portion lᵢ may differ from a length of the outer portion lₒ. The length of the top edge lₜ of the part 22 may be different from a length of the bottom edge l_{b} of the part 22. The length between the bottom of the container and the top of the container may change gradually. In FIG. 1H, the individual parts 22 are shown having a greater dimension at the top and lesser dimension at the bottom of each part.

The hole, aperture, or opening 26 defined by the walls of the parts 22, is structured to accommodate a plant in a starter medium. The starter medium is a medium where the plant is grown from seed or tissue culture. The starter medium may be agar, sterile soil, sterile grow plug, or the like. The hole 26 may be defined by an internal shape or surface areas of the individual part(s) 22. The central gap or hole 26 may be adjusted by placement of the individual parts close to one another or further apart from one another.

The plug 20 may have an open position and a closed position. In an open position, the plug includes one or more parts as described herein, the parts being in any orientation, apart from one another. In the closed position, the plug is assembled, and the individual parts are coordinating, cooperating, in close contact, or a combination thereof.

FIG. 1B shows a perspective top view of a plug 20 in an open position. FIG. 1H show a perspective side view of a plug 20 in its closed position. FIG. 1C illustrates a schematic top view of a plug 20 in an open position. The plug 20 in at least some of the illustrated embodiments includes two identical parts 22. In contrast, FIG. 1D shows a plug 20 in a closed position, in which three individual parts 22 cooperate to form a circular plug 20. The cooperating parts 22 form a hole 26 in the central portion of the plug 20.

The individual parts 22 may be identical, symmetrical, asymmetrical, coordinating, cooperating, have the same or different property or properties. The parts 22 may have complimentary shapes such as half-moons, semi-circles, or other shapes featuring a void or recess in the center. However, the parts 22 may have an initial shape while being molded and sold and a final shape, which is different, when inserted into a container.

In a non-limiting example, the parts 22 may be flat, flat sheet, which is foldable such that the final shape of the parts assembled together is a semi-circle, half-moon, or a full circle. Alternatively, the parts may form a wavy sheet or a sheet with an undulating surface, as is shown in FIG. 9. The undulation may provide additional growth/air space for the plant roots. Two or more wavy sheets may be combined to form the assembled rounded shape of the plugs disclosed herein. The texture and roughness of the surface may be uniform or non-uniform throughout each part.

As was discussed above, the parts 22 may have uniform or non-uniform dimensions. For example, the parts 22 may have the same thickness throughout the part area. Alternatively, at least one portion of a part may have a different thickness. A non-limiting example of such part may be one or more edge portions or a central portion of a part. The portion with decreased thickness may add flexibility and allow for bending of the part to accommodate a grow plug or another article housing the seedling or young orchid plant.

In non-limiting examples, FIGS. 1A-1D show parts 22 of the plugs 20 having the same dimensions throughout the parts' lengths. In FIGS. 1E and 1F, the parts 22 have a first portion 27 with a first thickness t1 and at least a second portion 28 having a second thickness t2 different than the first thickness. The thickness t1 to t2 may decrease gradually such as in FIGS. 1E and 1F or abruptly such as in FIG. 1G.

The end portions of each part may include one or more interlocking or cooperating features. The interlocking mechanism may include one or more protrusions, projections, indentations, apertures, raised portions, dents, notches, tapers, overlaps, hooks, or the like. A non-limiting example of such features may include a gradually decreasing portion slidable against another gradually decreasing portion. Such portions 32 may be present on the same or different parts as is shown in FIGS. 1E, 1F, and FIG. 2A. A non-limiting example of an interlocking mechanism is shown in FIGS. 1G and 2B, where the end portions 32 are configured to have complimentary shapes which fit within one another.

The parts 22 may include an enlarged top portion, muffin-shaped, or collar top 29, as is shown in FIG. 1. Alternatively, the parts 2 may be free of the enlarged portion such that the parts have a relatively even edge of the same dimensions as the remainder of the plug sides or walls. Examples of such embodiment are shown in FIGS. 1B and 1H.

Providing the plug 20 in two or more parts 22 provides several advantages. Firstly, the parts 22 may be assembled around a starter plug, enclose the starter plug in a flexible manner, providing enough suppleness such that the growing air roots may grow between and around the parts. As a result, the grown plant may remain in the same type of medium from seed to maturity. For example, if the plant is initiated in a formed material of a starter plug, the herein-disclosed parts 22 may enclose the started plug, and the roots may keep developing around and through the parts. This helps to inhibit transplant shock and avoids slow down associated with adaptation to a different type of media.

Since the plant is spared the transplant shock, better growth has been observed. As a result, the plant's growth is accelerated, and the plant may be moved from the greenhouse faster, thus results in in an increased speed to market. Alternatively, if kept in the greenhouse for a typical length of time, the plant can reach advanced growth compared to the same type of plant grown in traditional orchid media such as bark or sphagnum moss. Additionally, because of better growth, there is a lesser need to apply fungicides, pesticides, heat, lighting, or their combination. Growth trial results from orchid plant trials in the herein-disclosed medium and in bark is shown in Example 1.

Secondly, the parts 22 are configured to flexibly fit within a container and their installation is fast. Additionally, the growers may apply a more efficient watering regime, thus gaining savings on watering and fertilizer use. The improved, more efficient watering regimen has also been applied on the retail level with improvements in shelf life and higher percentage of plants being thriving and being sold.

Thirdly, providing two or more parts 22 is efficient from a production standpoint as a molding tray may fit a greater number of smaller parts than a single circular part. Production of the separate parts 22 may lead to line time increase and improved cycle time. Additionally, transportation of the discreet parts 22 is more efficient than transportation of round plugs in one piece as more parts may fit in the same space within a packaging. The herein-mentioned advantages are illustrated by Example 2. Overall, the efficiency of packing may be increase by up to about 10% and production efficiency by up to about 350%. The herein disclosed improvement thus represents significant advantages.

However, it is envisioned that the plug 20 may include a single part 22. The single part 22 may have one or more portions with a different thickness, as was described above, allowing flexibility and moldability of the part within the container and around the starter medium. The single part 22 may also feature cooperating edge portions which may slide against each other, interlock, or cooperate in a different manner. Non-limiting examples of a plug 20 formed from a single part 22 is shown in FIGS. 2A, 2B, and 9.

The single part 22 may be manufactured from a sheet which may be rolled, cut, dimensioned as needed. For example, the sheet may be manufactured as a continuous sheet, which is cut at specific dimensions and later formed into an assembled shape as disclosed herein. The growing medium may be manufactured as a roll.

The plug 20 may be a component of a plant cultivation assembly such as an orchid cultivation assembly. The assembly may include a container, a starter medium, the plug 20, or a combination thereof. The overall shape of the plug 20 is configured to fit within a planting container used to grow the plant. A planting container typically has a circular cross-section, open top, and a bottom featuring one or more apertures or holes. The container may have one or more sides defining a central aperture. The bottom may be flat or include a raised portion protruding towards the top of the container. A non-limiting example of the containers 34 is shown in FIG. 3.

As was mentioned above, the overall shape of the plug 20 includes a recess to form a central hole 26. The central hole 26 may be surround and/or accommodate a starter plug or another propagation medium with a seedling or young plant. The plug 20 is thus placed between the sides of the container and the sides of the starter medium. A non-limiting example of a starter medium 40, in this case a start plug including a binder, is shown in FIG. 4.

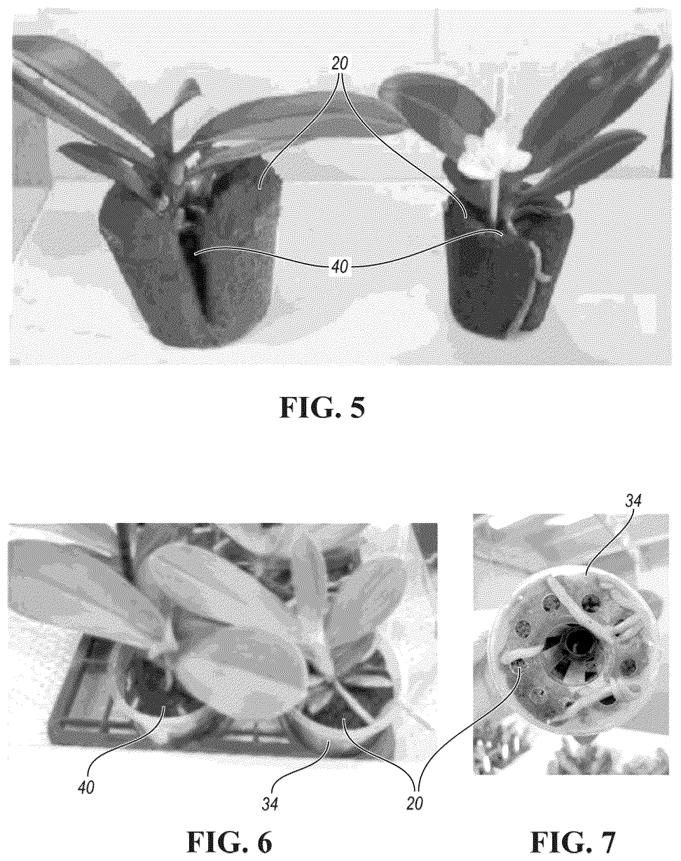

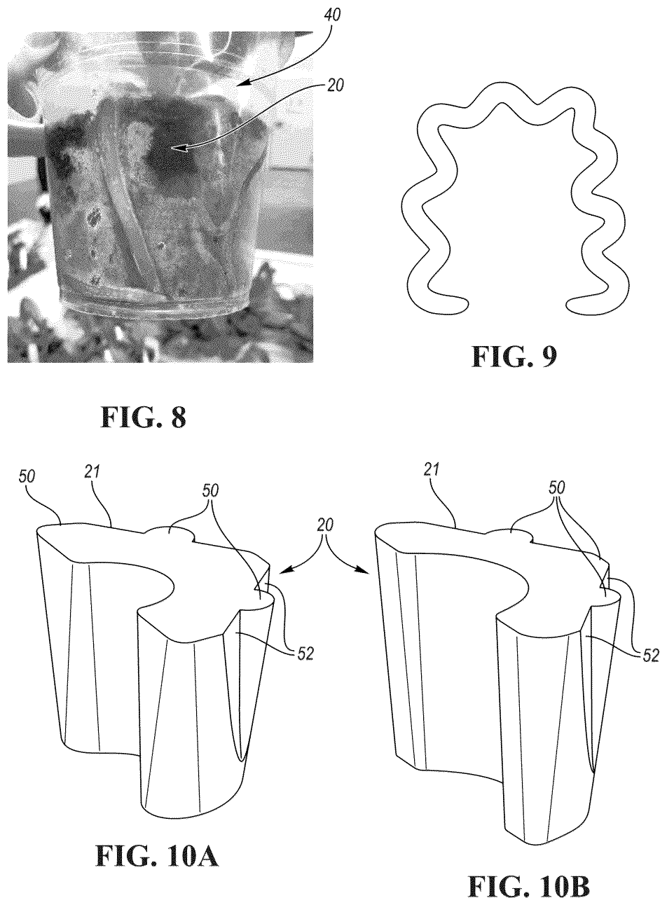

FIG. 5 shows two non-limiting examples of the plug 20 disclosed herein placed around and in close proximity to starter materials 40 supporting adult orchid plants. FIG. 6 shows the entire orchid cultivation assembly including the container 34, plug 20, and starter material 40. FIG. 7 shows a bottom view of a container 34 with a plug 20 inserted within the container 34. As can be seen in FIG. 7, the plug 20 has sufficient rigidity to offer a support for the roots to hold onto the plug and enable growth within the container. The light green color of the roots indicates healthy root development. Unlike in other media, the bottom portion does not have any decayed material which would cause rot of the roots. FIG. 8 provides an alternative view of the developing root system of the orchid within the container with the herein-disclosed plug 20.

The dimensions of the individual parts 22 and the plug 20 may vary to accommodate different dimensions of containers and starter media. Non-limiting example diameters of the plugs 20 may be about 5-20, 6-15, or 9-12 cm.

Since a starter medium is inserted within the central aperture 26 of the plug 20, the plug allows for custom positioning of the starter medium with respect to height of the plug. For example, the starter medium may be inserted such that the bottom of the starter medium is in contact with the bottom portion of the plug 20. Alternatively, the bottom of the starter medium may be in contact with a middle portion of the plug 20.

In comparison to the prior art media, the herein-disclosed plug 20 is a uniform, firm, and self-supporting structure and not loose fill media. The plug 20 includes 1 or up to about 10 pieces or individual parts while the loose fill media include dozens or hundreds of individual parts. The firmness of the herein-disclosed plug 20 supports the plant root growth and accommodates the root needs for attaching. For example, the physical support of the plug 20 mimics branches of a tree which an orchid would attach to in its natural habitat. Hence, the plug 20 is a solid growing medium. The plug 20 may be a unitary growing medium. Besides providing a firm structure the roots may attach to, the solid structure of the plug 20 provides a physical barrier configured to prevent damage to the plant and its roots.

Furthermore, with typical growing media, an orchid seedling or tissue culture is transplanted from the starter medium into a pot as a young plant and transplanted at least one more time as an adult plant. As was mentioned above, transplanting may trigger damage to the plant, slow its growth, flowering, and overall development, and is labor and time intensive. In contrast, the orchid cultivation assembly disclosed herein eliminates the need for transplanting. The assembly may include a start grow plug fitting snuggly within the plug part(s) which in turn fit within a container. As such, the tissue culture in a starter medium may be placed within the plug 20 disclosed herein within a container and remain there as a young plant and as an adult.

Additionally, the plug 20 and/or the assembly disclosed herein improves automated processing of the orchid cultivation. It has also been found, that in comparison to other media, the plug 20 encourages faster root growth, faster plant growth, and increased amount of flower spikes.

Since the plug 20 is semi-rigid to provide support but is also flexible enough to allow insertion of the starter material within the central aperture 26 of the plug, root and leaf damage may be eliminated.

An additional advantage of the herein-disclosed plug 20 stems from its homogenous composition. The plug 20 retains and distributes moisture, humidity evenly throughout the plug. This is in contrast to the loose media which typically sporadically wet, keeping moisture in certain areas while other areas of the bark medium within the container remain dry. For example, in loose media, the water distribution is different than in the porous material of the herein-disclosed plug 20. In loose media, the water finds paths of the least resistance, being pulled by gravity, and not hydrating evenly throughout the medium.

The material of the herein-disclosed plug 20 is hydrophilic, structured to wet and keep moisture, thus providing water and nutrients to the plant throughout its surface area while at the same time preventing pooling of water at the bottom of the container.

Importantly, even or uniform distribution of water also means even or uniform distribution of nutrition to the plants since the liquid feed is the main source of nutrients for the plants. Without limiting the disclosure to a single theory, the uniform moisture distribution is credited at least partially with the increased rate of root growth, plant growth, and formation of spikes which has been observed during test trials of the herein-disclosed plugs.

The plug's 20 composition may include one or a mixture of organic material such as peat, coco coir, wood fiber, bark fiber, calcined clay particles, jute, hemp, sisal, etc. A non-limiting ratio of portions of the organic material, such as coir:peat, coir:wood fiber, etc. may be about 1:1, 1:2, 1:3, 1:4, 1:5, 1:6, 1:7, 1:8, 1:9, 1:10, or vice versa.

The plug 20 may further include a binder. The binder may be based on polyurethane chemistry. The binder may include water-based isocyanate. The binder may include bio-based material(s), biodegradable material(s), or both. The binder may include a natural or synthetic latex, or a heat-set polymer or thermoset. The input binder material may be included in about 0.5-10, 2-8, or 3-5 wt. % of the total weight of the mixture. The binder and the organic material may be homogenized, heated, and compressed into a desirable shape described above. The homogenized mixture may be a slurry. The slurry may be provided into a tray/mold. The binder may be biobased, biodegradable, or both.

Alternatively or in addition to the binder, the plug 20 may include a mesh or netting material. The mesh or netting relates to a fabric including open spaces between the yarns. The mesh may have a lightweight heft and permeable texture. The mesh material may be a textile, geotextile, fabric, a loosely woven material. The mesh may be natural, organic, or synthetic.

The mesh may be filled with the organic material(s) disclosed herein, wetted, heated, dried, or a combination thereof, such that the material swells, and the mesh-filled material forms a structure configured to provide physical support to the plant, as described herein.

The plug 20 is thus a physical support or stabilization article. The plug 20 is a dimensionally stable support article providing physical support around a plant, to one or more plant parts such as roots.

The plug 20 may be sterile, spongy, porous. The plug 20 may be sufficiently firm for the plant to hold onto, flexible enough to install in the container without breaking, and porous or airy at the same time, providing enough air space and water holding capacity to ensure healthy root and plant growth of the plants. Due to the ability to adjust the parts 22 of the plug 20 within a container, a custom fit may be achieved, serving unique needs of individual plants such as air root growth and direction. The outer surface of the plug 20 may be open cell, free of a skin.

To further balance the air and water holding capacity of the plug 20 within a container, one or more additional protrusions 50 and/or cutouts 52 may be provided on the outer portions of the parts 22 of the plug 20. Non-liming examples of such protrusions/cut-out are shown in FIGS. 10A and 10B. As FIGS. 10A and 10B illustrate, the protrusions 50 are present on the outer side or surface of one or both parts 22. Each part 22 may include 1, 2, 3, 4, or 5 protrusions or more. The protrusions 52 may have the same or different shape, dimensions, or both, or differ in shape, dimensions, or both. The protrusions 52 may be spacer apart regularly, randomly, or in a pattern.

The shape of the shown protrusions 52 in FIG. 10A includes a half cone with a semi-circular top. The diameter of the protrusion 52 is lessening from the top of the plug or part towards the bottom. The lowest tip of the protrusions 52 may be above or at the bottom of the part 22 or plug 20. The protrusions 52 may be rounded or have sharp edges. The protrusions 52 may be made from the same material as the remainder of the plug 20 or part 22. However; the protrusions 52 may include different shapes such as a trapezoid shown in FIGS. 10A and B.

When applied, the plug 20 or part 22 with the protrusions 52 is inserted within a container such as those shown in FIGS. 6-8. Differently shaped containers are also contemplated for this purpose. Within the container, a gap may form between the outer sides 22 of the plug 20 and the inner wall of a container where the cutouts 52 have been created and are present. The gap allows additional influx of air, preventing lack of air in case of application of excess water.

The plug parts 22 and plugs 20 disclosed herein may have the following properties measured by the testing method FYS1: Cf PTOG n 31 (1990) accredited by RvA. Moisture content may be about 60-90, 64-88, or 65-85%. Moisture content may be about, at least about, or at most about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90%. Bulk density may be about 100 to 140 kg/m³. Bulk density may be about, at least about, or at most about 100, 105, 110, 115, 120, 125, 130, 135, or 140 kg/m³. Shrinkage of the plus part and plugs may be about 12-35, 14-32, or 16-30%. Shrinkage may be about, at least about, or at most about 12, 13, 14, 15, 16, 17, 18, 19, 20, 21, 22, 23, 24, 25, 26, 27, 28, 29, 30, 31, 32, 33, 34, 35, 36, 37, 38, 39, or 40%. Porosity may be about 90-96-, 91-95, or 92-94%. Porosity may be about, at least about, or at most about 90, 91, 9,2 93, 94, 95, or 96%.

Water content and air content as well as water rate of organic matter measured at different pressure height is shown in Example 3. Due to the water and air balance, especially compared to bark and sphagnum moss traditionally used for orchid growth, less drying and improved airflow has been observed.

A method of making the growing medium is disclosed herein. The plug 20 may be manufactured from the components named above such as the binder, organic material(s), mesh, or a combination thereof. The weight ratio may be about 0.5-10, 2-8, or 3-5 wt. % binder and 90-99.5, 92-98, or 95-97 wt. % organic material(s). Additional materials are contemplated such as fertilizers.

The binder and the organic material(s) may be mixed together, made into a slurry, poured into a mold and compressed while heat, moisture, pressure, or a combination of the described conditions is applied. Once pressed, the formed parts of the plugs may be cooled and removed from mold(s). Other manufacturing techniques resulting in the desirable shape of the parts may be implemented. The individual plug parts may be formed directly into the desirable shape such as half-moons, semi-circle, etc. Alternatively, the individual plug parts may be formed as flat sheets which may be shaped into the desirable final shape while being installed into the container. Alternatively still, the parts 22 of the plug 20 may be formed as a sheet, cut into desirable dimensions, and formed into a final desirable shape by insertion into the container. The sheet may have uniform or non-uniform thickness, as was described above.

While the disclosure relates to orchids, the growing medium disclosed herein may also relate to other plant species facing similar challenges such as root rot due to disintegrating potted media and/or susceptibility to damage during transport. Non-limiting example plants which may benefit from and be placed into the growing medium disclosed herein may thus include house plants, e-commerce transport plants, and plants in retail in certain climates featuring high temperatures, high winds, or both as the growing medium's even moisture distribution may prolong shelf life.

A method of using the plug 20 may include providing the plug as a growing medium for orchid and other plants. The plants may be in a second stage of plant growth, after tissue culture or seed start stage is completed, seedlings, young plants, adult plants, or a combination thereof.

The method may include inserting the plug 20 part(s) 22 into a container. The inserting may include placing the plug part(s) 22 between the side(s) of the container and side(s) of a starter medium. The inserting may include fitting the plug 20 between the container side(s) and the start medium side(s). The fitting may be snug or loose fit. The inserting may include positioning one or more edge portions of the parts in a cooperating or overlapping manner. The inserting may include engaging individual portions of cooperating mechanisms.

The method may include growing the plant in the plug 20 parts 22 until and including the adult stage, blooming part of the life cycle, and the resting part of the life cycle, for the remainder of the plant life. The growing may include providing water, nutrient solution repeatedly, at predetermined intervals. The growing may include adjusting edge portions' location, repositioning or adjusting position of the plug part(s).

### Examples

### Example—Orchis Plants Growth Trials

Trial data from two growth trials comparing orchid plant growth and blooming capabilities in bark and herein-disclosed plugs is shown in Tables 1 and 2. Trial1 featured a first orchid species different from a second orchid species in Trial 2. Overall, the trials shown more robust plant growth, an increased quantity of spikes, buds, and flowers of orchid plants grown in the plugs disclosed herein in comparison to orchid plants grown in bark.

TABLE 1
Results of Trial no. 1

| Treatment | Bark | Plug | Bark | Plug |
|---|---|---|---|---|
| Type of pot and | 9 cm | 12 cm | 9 cm | 12 cm |
| plug | | | | |
| # leaves | 10.87 | 10.53 | 10.4 | 11.07 |
| # roots | 21.9 | 24.9 | 23.4 | 26.73 |
| Leaf surface | 372.95 | 374.52 | 752.55 | 891.94 |
| [cm] | | | | |
| Fresh weight of | 30.48 | 31.81 | 72.08 | 78.76 |
| roots [g] | | | | |
| Dry weight of | 4.24 | 3.97 | 7.19 | 7.07 |
| roots [g] | | | | |

TABLE 2
Results of Trial no. 2

| Treatment | Bark | Plug | Bark | Plug |
|---|---|---|---|---|
| Type of pot and | 9 cm | 12 cm | 9 cm | 12 cm |
| plug | | | | |
| Dry weight of | 45.84 | 45.93 | 162.23 | 199.43 |
| blooms and | | | | |
| stems | | | | |
| Fresh weight | 30.84 | 30.06 | 69.41 | 88.04 |
| branches | | | | |
| # branches | 2.0 | 2.17 | 1.87 | 1.93 |
| # blooms and | 34.47 | 38.30 | 19.87 | 28.33 |
| buds | | | | |

### Example 2—Production Efficiency

Production and transportation efficiency regarding the parts and plugs disclosed herein was assessed. The results of the assessment are shown in Table 3 below. 12 cm and 9 cm refers to a diameter of the circular plugs used for orchid plant growth.

TABLE 3
production and transportation efficiency for 12 cm and 9 cm parts and
plugs

| 12 cm | Production | Production | | Production | |
|---|---|---|---|---|---|
| circular | speed | speed | Production- | [plug/min/ | Transportation |
| plug | [moulds/min] | [plugs/min] | manpower | employee] | [plug/box] |
| 1 part = | 12 | 144 | 19 | 7.5 | 48 |
| collar | | | | | |
| 2 semi-circle | 20 | 520 parts = | 10 | 26 | 104 parts = 52 |
| parts for | | 260 | | | plugs |
| assembly | | plugs/min | | | |
| into a | | | | | |
| circular plug | | | | | |
| 9 cm plug | | | | | |
| 1 part = | 12 | 288 | 19 | 15 | 96 |
| collar | | | | | |
| 2 semi-circle | 20 | 1080 parts = | 10 | 54 | 216 parts = 108 |
| parts for | | 540 | | | plugs |
| assembly | | plugs/min | | | |
| into a | | | | | |
| circular plug | | | | | |

### Example 3—Water and Air Content Properties

Water content, air content, and water rate of organic matter was measured by FYS 1: Cf PTOG n 31 (1990) at different pressure height for 8 samples of plugs according to embodiments disclosed herein. Table 4 below shows results of the testing. Samples 1-8 were formed as two cooperating parts.

TABLE 4
water and air content properties of Samples 1-8

| Sample | Pressure | | | | | | | | | | |
|---|---|---|---|---|---|---|---|---|---|---|---|
| no. | height | | 1 | 2 | 3 | 4 | 5 | 6 | 7 | 8 | Range |
| Water | −3 | cm | 75 | 81 | 82 | 81 | 70 | 87 | 79 | 76 | 70-87 |
| content | −10 | cm | 64 | 74 | 65 | 79 | 67 | 55 | 57 | 67 | 55-79 |
| [%] | −32 | cm | 43 | 50 | 38 | 68 | 50 | 34 | 39 | 45 | 34-68 |
| | −50 | cm | 41 | 45 | 34 | 54 | 45 | 30 | 35 | 42 | 30-54 |
| | −100 | cm | 40 | 43 | 32 | 51 | 42 | 28 | 33 | 40 | 28-51 |
| Air | −3 | cm | 19 | 13 | 11 | 12 | 22 | 7 | 15 | 17 | 12-22 |
| content | −10 | cm | 30 | 19 | 28 | 14 | 26 | 40 | 36 | 25 | 14-40 |
| [%] | −32 | cm | 51 | 44 | 55 | 24 | 43 | 60 | 55 | 47 | 24-60 |
| | −50 | cm | 53 | 48 | 60 | 39 | 48 | 64 | 58 | 51 | 39-64 |
| | −100 | cm | 54 | 50 | 61 | 42 | 51 | 67 | 61 | 53 | 42-67 |
| Water | −3 | cm | 9.8 | 10.0 | 8.4 | 8.1 | 6.4 | 11.0 | 9.8 | 9.0 | 8.1-11.0 |
| rate of | −10 | cm | 8.3 | 9.4 | 6.7 | 7.9 | 6.1 | 6.8 | 7.1 | 8.0 | 6.1-9.4 |
| the | −32 | cm | 5.5 | 6.3 | 3.9 | 6.8 | 4.5 | 4.3 | 4.8 | 5.4 | 3.9-6.8 |
| organic | −50 | cm | 5.3 | 5.8 | 3.5 | 5.4 | 4.1 | 3.7 | 4.4 | 5.0 | 3.5-5.8 |
| matter | −100 | cm | 5.2 | 5.5 | 3.3 | 5.1 | 3.8 | 3.4 | 4.1 | 4.7 | 3.3-5.5 |

[g]

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A plant growing medium comprising:
a self-supporting, semi-rigid body including at least two discreet parts, each part having a set of dimensions including a first thickness and a recess in an inner portion of the part, the at least two discreet parts being structured to cooperatively form the body, the body structured to provide support to plant roots.

2. The plant growing medium of claim 1, wherein the at least two discreet parts are symmetrical.

3. The plant growing medium of claim 1, wherein the at least two discreet parts include more than two parts.

4. The plant growing medium of claim 1, wherein each one of the at least two discreet parts includes at least one edge portion, at least some of the edge portions having a second thickness different from the first thickness.

5. The plant growing medium of claim 4, wherein the growing medium has an open position of having the edge portions distanced from one another and a closed position of having the edge portions in contact with one another.

6. The plant growing medium of claim 1, wherein the body is hydrophilic.

7. The plant growing medium of claim 1, wherein the plant growing medium is an orchid growing medium.

8. The plant growing medium of claim 1, wherein the semi-rigid body has a moisture content of about 60-90%.

9. The plant growing medium of claim 1, wherein the semi-rigid body has a bulk density may be about 100 to 140 kg/m³.

10. An orchid growing system comprising:
a plant growing medium comprising a self-supporting, semi-rigid body including at least two separate parts, each part having a set of dimensions including a first thickness, the at least two discreet parts being structured to cooperatively form the body, the body structured to have a recess and provide support to plant roots;
a plug supporting an orchid seedling, the plug disposed within the recess of the body, the plug and the body being made of fibrous material; and
a container supporting the body and the plug such that the body is disposed between the plug and the container.

11. The orchid growing system of claim 10, wherein the body is flat.

12. The orchid growing system of claim 10, wherein the body is foldable.

13. The orchid growing system of claim 10, wherein the growing medium has an open position of having the edge portions distanced from one another and a closed position of having the edge portions in contact with one another.

14. The orchid growing system of claim 10, wherein the thickness between the central portion and/or the edge portions and the reminder of the body changes gradually.

15. The orchid growing system of claim 10, wherein the plant growing medium is an orchid growing medium.

16. The plant growing medium of claim 10, wherein the semi-rigid body has a moisture content of about 60-90%.

17. The plant growing medium of claim 16, wherein the semi-rigid body has a bulk density may be about 100 to 140 kg/m³.

18. An orchid cultivation assembly comprising:
a container having one or more sides defining a central aperture;
a self-supporting, semi-rigid hydrophilic body disposed withing the central aperture of the container, the hydrophilic body including at least two parts cooperating to form a recess in the body; and
an orchid starter material located in the recess of the hydrophilic body; and
wherein the orchid starter material is capable of forming plant roots and body is structured to provide support to plant roots.

19. The plant growing medium of claim 18, wherein the semi-rigid body has a moisture content of about 60-90%.

20. The plant growing medium of claim 19, wherein the semi-rigid body has a bulk density may be about 100 to 140 kg/m³.
